(19) United States
(12) Patent Application Publication
(10) Pub. No.: US 2009/0185295 A1
(43) Pub. Date: Jul. 23, 2009

(54) ATTACHABLE MAGNIFIER DEVICE

(76) Inventor: CRAIG NELSON, Holmdel, NJ (US)

Correspondence Address: MALDJIAN & FALLON LLC, 365 BROAD ST. , 3RD FLOOR, RED BANK, NJ, 07701, US

(21) Appl. No.: 12/356,658

(22) Filed: Jan. 21, 2009

Related U.S. Application Data
(60) Provisional application No. 61/022,191, filed on Jan. 18, 2008.

(51) Int. Cl. G02B 25/00

(52) U.S. Cl. 359/807

(57) ABSTRACT

Embodiments of the present invention generally relate to attachable magnification devices. More specifically, embodiments of the present invention relate to a magnification device mountable on file folders or other organizational items. In one embodiment of the present invention, an attachable magnification device comprises a base portion, a substantially transparent or translucent magnifying surface, a means for removably attaching the attachable magnification device to a host article, and a label holding portion defined between the base portion and the magnifying surface.

### CROSS-REFERENCE TO RELATED APPLICATIONS

This application claims the benefit of U.S. Provisional Patent Application No. 61/002,191, entitled “Attachable Magnifier Device,” filed Jan. 18, 2008, the disclosure of which is hereby incorporated by reference in its entirety.

### BACKGROUND OF THE INVENTION

1. Field of the Invention

Embodiments of the present invention generally relate to attachable magnification devices. More specifically, embodiments of the present invention relate to a magnification device mountable on file folders or other organizational items.

2. Description of the Related Art

In many medium- and large-sized businesses and corporations, file management and organization can be a very difficult task. Particularly, with thousands or even millions of files being held by a company at any given time, it may be a Sisyphean task to isolate a single or a small set of files from a large file depository.

One particular obstacle to finding a single file in a large file depository is due to the typical orientation and configuration of stacked files with respect to the position of the user. Typically, file folders are stacked so that the flat back surface of one file is adjacent to the flat front surface of another file placed behind the first file. In such a manner of stacking, the result is that the file folders all face in the same direction. However, due to the basic structure of file folders generally in use today, the tabs or labels which are commonly found on file folders may be obscured or hidden, thus concealing important identification data from an individual who is scanning through files to find a specified folder, thus requiring such an individual to physically touch and/or lift up each file folder in order to read the title or identification data on the tab or label. As such, finding a single file or a set of files in such a large depository is commonly and properly analogized with “finding a needle in a haystack.”

Thus, there is a need for an attachable magnifier device, particularly for use with file folders and like objects.

### SUMMARY OF THE INVENTION

Embodiments of the present invention generally relate to attachable magnification devices. More specifically, embodiments of the present invention relate to a magnification device mountable on file folders or other organizational items. In one embodiment of the present invention, an attachable magnification device comprises a base portion, a substantially transparent or translucent magnifying surface, a means for removably attaching the attachable magnification device to a host article, and a label holding portion defined between the base portion and the magnifying surface.

In accordance with another embodiment of the present invention, a file folder comprises a primary surface, and an attachable magnification device comprising: a base portion, a substantially transparent or translucent magnifying surface, a means for attaching the attachable magnification device to primary surface, and a label holding portion defined between the base portion and the magnifying surface.

In accordance with yet another embodiment of the present invention, An organizational apparatus comprises a base portion, a substantially transparent or translucent magnifying surface, at least one of a hinge, a pin, a pivot joint, a clip, a spring-loaded lock, or a tab-like projection, for removably attaching the attachable magnification device to at least one of a file folder, a book, a magazine, a newspaper, a binder, or a report, and a label holding portion defined between the base portion and the magnifying surface, having a label substantially disposed therein.

### BRIEF DESCRIPTION OF THE DRAWINGS

So the manner in which the above recited features of the present invention can be understood in detail, a more particular description of embodiments of the present invention, briefly summarized above, may be had by reference to embodiments, one of which is illustrated in the appended drawings. It is to be noted, however, the appended drawings illustrate only typical embodiments of embodiments encompassed within the scope of the present invention, and, therefore, is not to be considered limiting, for the present invention may admit to other equally effective embodiments.

FIG. 1 is a front view of an attachable magnifier device in accordance with one embodiment of the present invention;

FIG. 2 is a side view of an attachable magnifier device in accordance with one embodiment of the present invention;

FIG. 3 is a bottom view of an attachable magnifier device in accordance with one embodiment of the present invention;

FIG. 4 is a front view of an attachable magnifier device in accordance with another embodiment of the present invention;

FIG. 5 is a side view of an attachable magnifier device in accordance with another embodiment of the present invention;

FIG. 6 is an isometric view of an attachable magnifier device in accordance with yet another embodiment of the present invention;

FIG. 7 is a front view of an attachable magnifier device in accordance with another embodiment of the present invention;

FIG. 8 is a side view of an attachable magnifier device is accordance with one embodiment of the present invention;

FIG. 9 is an isometric view of a an attachable magnifier device in accordance with yet another embodiment of the present invention;

FIG. 10 is a side view of an attachable magnifier device is accordance with yet another embodiment of the present invention; and

FIG. 11 is a front view of an attachable magnifier device in accordance with another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the Figures.

### DETAILED DESCRIPTION OF THE INVENTION

Embodiments of the present invention generally relate to attachable magnification devices. More specifically, embodiments of the present invention relate to a magnification device mountable on file folders or other organizational items.

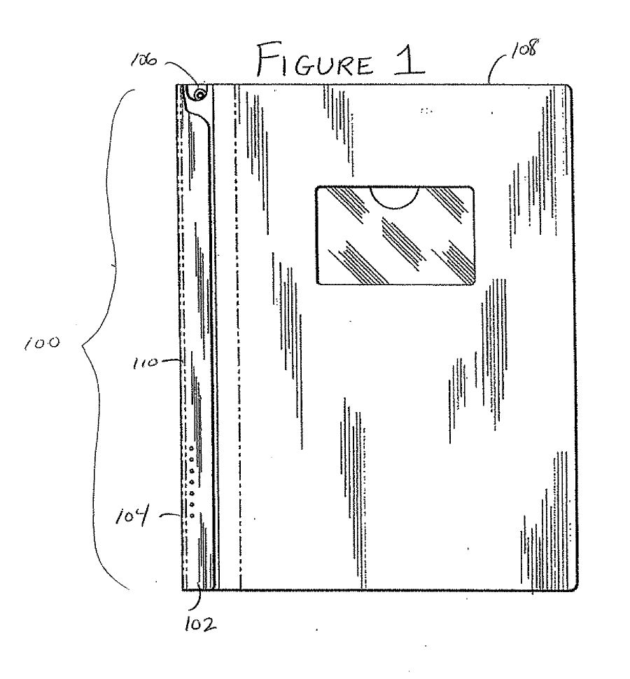

FIGS. 1-3 illustrate an attachable magnifier device 100 in accordance with one embodiment of the present invention in use on a file folder 108. In accordance with one embodiment of the present invention, an attachable magnifier device 100 may comprise a base portion 102, at least a magnifying surface 104 comprising a transparent or translucent material, and at least a means 106 for removably attaching the attachable magnification device 100 to a host article. A host article may comprise a folder, a book, a magazine, a newspaper, a binder, a report, or any other article feasible in the context of the present invention.

In one embodiment, as depicted in FIG. 1, the attachable magnifier device 100 of the present invention is placed across the closed end of a bifold file folder 108. In such an embodiment, the attachable magnifier device 100 may additionally serve as a binder to keep loose papers in the folder, as in the manner of a book. A file folder 108 in accordance with one embodiment of the present invention may comprise at least a top surface, a bottom surface, and a plurality of sides. In accordance with one embodiment of the present invention, one or more of the side surfaces of the file folder 108 may have a substantially minimal thickness. In another embodiment of the present invention, the attachable magnifier device 100 is pivotally connected to an article via a hinge, a pin, a pivot joint, or any other means 106 of attachment feasible in the context of the present invention. For example, in one embodiment, a file folder 108 is provided with an attachable magnifier device 100 pivotally connected via a rivet or pin on a top corner along the closed edge of the file folder 108.

In accordance with one embodiment of the present invention, the attachable magnifier device 100 may be integral with a file folder 108, permanently attached to the file folder 108, or removably attached to the file folder 108. Such attachment means 106 allow for the attachable magnifier device 100 to be manufactured and produced together with the file folder 108 or separate from the file folder 108.

In one embodiment of the present invention, the attachable magnifier device 100 has at least one magnifying surface 104. At least a magnifying surface 104 may be substantially semi-circular or semi-ovoid, or may have any shape feasible in the context of the present invention.

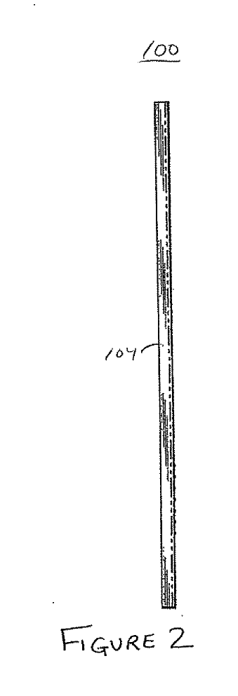

In one embodiment of the invention, an attachable magnifier device 100 may further comprise a label holding portion 110 disposed in the base portion 102 and in proximal relation to at least a magnifying surface 104. In accordance with another embodiment of the present invention, at least a label holding portion 110 is disposed in the base portion 102 of the attachable magnifier device 100 along a plane which is substantially parallel to at least a magnifying surface 104. In accordance with one embodiment of the present invention, a label may be inserted into a label holding portion 110 disposed in the attachable magnifier device 100, as shown in FIG. 2. A magnifying surface 104 concurrent with the closed edge of the bifold file folder 108 then magnifies the markings on the label, allowing a viewer to more easily read fine-print text. The label may be marked and may contain visual images, text (e.g., identification data, information regarding the contents of the corresponding file, etc.), or any other visual media feasible in the context of the present invention. Consequently, a person may read the information from a greater distance than would normally be possible.

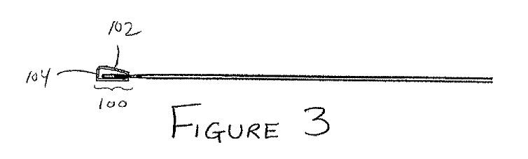

FIG. 3 shows a bottom view of an attachable magnifier device 100 in accordance with one embodiment of the present invention in use on the side surface of a bifold file folder 108. In one embodiment of the invention, the attachable magnifier device 100 is held onto an article by the device 100 exerting an elastic force onto the article, such as a spring-loaded lock or mechanism.

The attachable magnifier device 100 may comprise glass, polyethylene, polypropylene, polycarbonate, polymethyl methacrylate, or any other material of construction feasible in the context of the present invention. In some embodiments in which the attachable magnifier device 100 comprises a polymeric material, the device may additionally comprise fillers, stabilizers, additives, plasticizers, antioxidants, colorants, and/or any other polymer additive feasible in the context of embodiments of the present invention.

In many embodiments, the attachable magnifier device 100 additionally comprises a dying or tinting agent. Generally, however, the device is substantially translucent or transparent. Optionally, portions of the attachable magnifier device 100 may be opaque in nature.

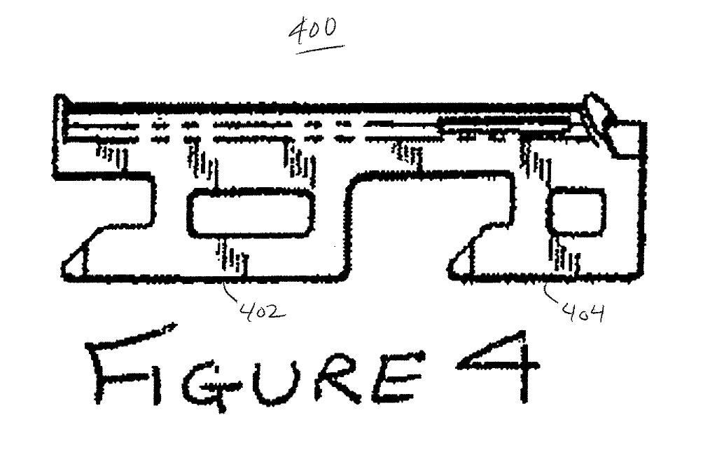

FIG. 4 shows an attachable magnifier device 400 in accordance with one embodiment of the present invention. Currently, commercially available hanging file folders may comprise a plurality of slots along the top inside edge of one or more surfaces of the folder. The slots typically comprise a series of spaced slots for holding in place an inserted tab projecting upwardly from the folder. Generally, the spacing is standardized, such that items may be adapted to the folders.

In an embodiment of the present invention, as shown in FIG. 4, an attachable magnifier device 400 may be attached to such a hanging file folder or other analogous article by utilizing the described slotted strip. The projections 402, 404 at the base of the attachable magnifier device 400 are inserted into slots in the slotted strip so as to secure the device 400 onto the folder. In one embodiment of the present invention, the attachable magnifier device 400 comprises at least a plurality of projections 402, 404 to secure the device 400 on the folder.

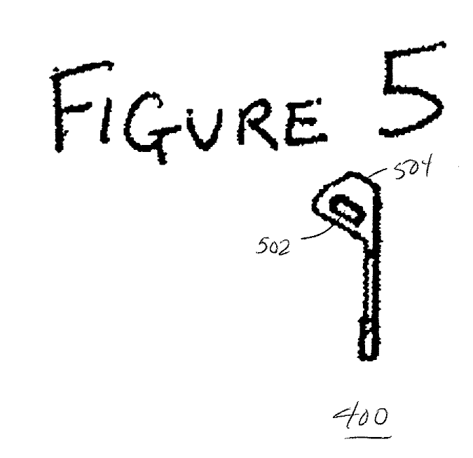

FIG. 5 portrays a side view of an attachable magnifier device 400 in accordance with one embodiment of the present invention. In one embodiment of the present invention, a marked label may be inserted into the label holding portion 502 near the top of the device 400. A magnifying surface 504 above the label may be angled on a diagonal or at any angle between about 0° and about 180° with respect to the horizontal. In such an embodiment, the magnifying surface 504 enlarges the image of the marked label and projects the image at an angle between about 0° and about 180° with respect to the horizontal corresponding to the angle of incline of the magnifying surface 504. In this manner, the projection of the text on the label is enlarged, thus allowing a viewer to read and view the text in a much simpler manner than would otherwise be permitted.

The embodiments depicted in FIGS. 4 and 5 are generally designed to extend only a portion of the length of a folder. For example, in one embodiment, the device 400 is about ⅓ of a length of a folder. By providing shorter devices in combination with folders having a plurality of slots along a top inside edge, each device 400 may be positioned in a folder, such that adjacent folders have a staggered series of devices. Often, when looking through crowded filing cabinets, the staggering of the file names (or titles) can be less burdensome when the labels are not all arranged in a difficult-to-read lineal group with one another. However, in accordance with one embodiment of the present invention, an attachable magnifier device 400 may be any length, including shorter than the folder, longer than the folder, or the same length as the folder.

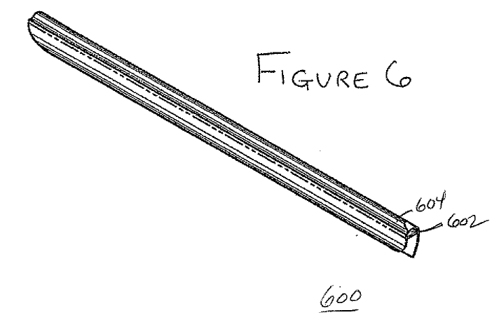

Referring now to FIG. 6, in one embodiment of the present invention, the attachable magnifier device 600 can be removably attached to a document or group of documents, as in the manner of a report cover spine. In such an embodiment, the attachable magnifier device 600 can be removed from the document or group of documents with ease. In this manner, the attachable magnifier device 600 acts as a binder to hold documents into a folder, and simultaneously serves as a magnifier. A marked label can be inserted into a label holding portion 602 near the spine of the device 600. The material on the label is then magnified through the magnifying surface 604 located on the spine of the attachable magnifying device 600.

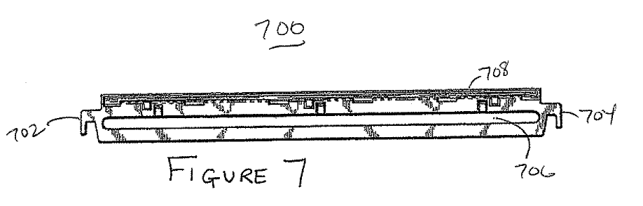

Referring now to FIG. 7, in another embodiment of the present invention, an attachable magnifying device 700 resembling the top of a hanging file folder. In this manner, in one embodiment of the present invention, the attachable magnifier device 700 comprises a hook 702, 704 on each end of the device 700. Additionally, the device 700 may have an aperture 706 in the middle of the structure. In such an embodiment, one end of a document, such as a newspaper or magazine, may be threaded into the aperture 706. The spine of the document can then rest on the bottom portion of the aperture 706. A marked label—for example, a label showing the name and date of a printed publication inserted used in conjunction with an embodiment of the present invention—can be inserted into an aperture 706 at the top of the structure. A magnifying surface 708 at the top of the structure, above the aperture 706 wherein is placed the label, will then enlarge a projection of the material on the label for simpler viewing by a viewer.

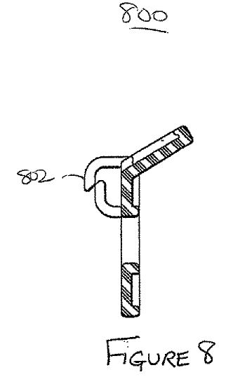

FIG. 8 shows a side view of an attachable magnifier device 800 in accordance with one embodiment of the present invention. As shown, in such an embodiment, the attachable magnifier device 800 may comprise one or more clips 802 which are mountable to a variety of surfaces and objects.

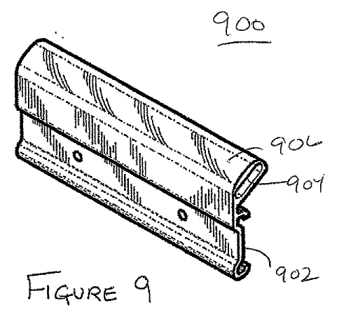

Referring now to FIG. 9, in another embodiment of the present invention, an attachable magnifying device 900 comprises a snap-on clip apparatus 902. The snap-on clip apparatus 902 may be mounted or secured onto a variety of surfaces and objects, including some of those found on standard American and foreign file folders. The device 900 additionally comprises a thin aperture 904 in which a marked label or other indicating article may be inserted. A magnifying surface 906 is located directly above the aperture 904. In one embodiment, the magnifying device 900 may be angled on a diagonal or any angle between about 0° and about 180° with respect to the horizontal. The magnifying surface 906 enlarges the projection of the label or other indicating means such that a viewer can more simply view the indicating means.

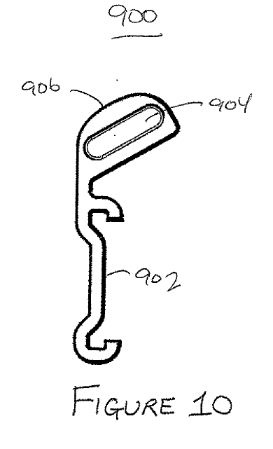

FIG. 10 illustrates a side view of the device 900 shown in FIG. 9 in accordance with one embodiment of the present invention. As shown, in one embodiment of the present invention, the snap-on clip apparatus 902 may be C-shaped. Additionally, in another embodiment of the present invention, the snap-on clip apparatus 902 is cleanly detachable—that is, it can be removed without causing the transfer or removal of any substantial amount of material.

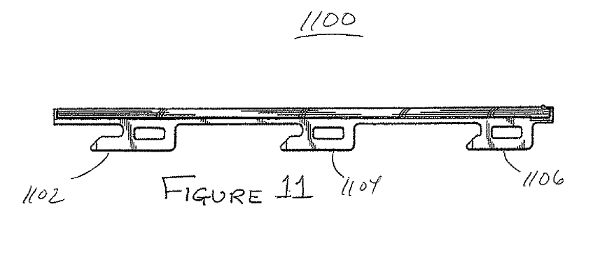

Referring now to FIG. 11, as previously stated, in one embodiment of the invention, the attachable magnifier device 1100 may comprise one or more tab-like projections 1102, 1104, 1106. As depicted in FIG. 11, in accordance with one embodiment of the present invention, an attachable magnifier device 1100 may comprise a plurality of pointed projections 1102, 1104, 1106, for example, three, as shown. As discussed above, commercially available hanging file folders may comprise a plurality of slots along the top inside edge of one or more surfaces of the folder. The slots typically comprise a series of spaced slots for holding in place an inserted tab projecting upwardly from the folder. Generally, the spacing is standardized, such that items may be adapted to the folders.

In an embodiment of the present invention, as shown in FIG. 11, an attachable magnifier device 1100 may be attached to such a hanging file folder or other analogous article by utilizing the described slotted strip. The projections 1102, 1104, 1106 at the base of the attachable magnifier device 1100 are inserted into slots in the slotted strip so as to secure the device 1100 onto the folder.

In one embodiment of the present invention, the attachable magnifier device 1100 extends over the entire length of a folder. An embodiment as depicted in FIG. 11 may be substantially similar to an embodiment as depicted in FIGS. 4 and 5.

As understood by embodiments of the present invention, the attachable magnifier device is adaptable to fit any existing folder, binder, or any other organizational item feasible in the context of the present invention. Thus, provided the essential elements of embodiments disclosed herein are maintained, additional embodiments of the present invention are suitable for any known article in the organization industry.

In an embodiment of the present invention, an additional magnifying surface is located on top of the original magnifying surface. This additional magnifying surface serves to provide additional magnification to the viewer.

While the foregoing is directed to embodiments of the present invention, other and further embodiments of the invention may be devised without departing from the basic scope thereof.

What is claimed is:

1. An attachable magnification device comprising:
a base portion;
a substantially transparent or translucent magnifying surface;
a means for removably attaching the attachable magnification device to a host article; and
a label holding portion defined between the base portion and the magnifying surface.

2. The attachable magnification device of claim 1, wherein the host article comprises at least one of a file folder, a hanging folder, a book, a magazine, a newspaper, a binder, or a report.

3. The attachable magnification device of claim 1, wherein the label holding portion is disposed in the base portion of the attachable magnification device along a plane substantially parallel to the magnifying surface.

4. The attachable magnification device of claim 1, further comprising a label substantially disposed in the label holding portion.

5. The attachable magnification device of claim 1, wherein the means for removably attaching the attachable magnification device to a host article comprises at least one of a hinge, a pin, a pivot joint, a clip, a spring-loaded lock, or a tab-like projection.

6. The attachable magnification device of claim 1, wherein the magnifying surface comprises at least one of glass, polyethylene, polypropylene, polycarbonate, polymethyl methacrylate or blends thereof.

7. The attachable magnification device of claim 6, wherein the magnifying surface comprises a colorant.

8. The attachable magnification device of claim 1, wherein the magnifying surface is substantially semi-circular or semi-ovoid.

9. The attachable magnification device of claim 8, wherein the magnifying surface is oriented at an angle between about 0° and about 180° with respect to the base portion.

10. The attachable magnification device of claim 1, wherein a portion of the attachable magnification device is opaque.

11. A file folder comprising:
a primary surface; and
an attachable magnification device comprising:
a base portion;
a substantially transparent or translucent magnifying surface;
a means for attaching the attachable magnification device to primary surface; and
a label holding portion defined between the base portion and the magnifying surface.

12. The file folder of claim 11, further comprising a label substantially disposed within the label holding portion.

13. The file folder of claim 11, wherein the primary surface comprises a plurality of slots therein for engaging the means for attaching.

14. The file folder of claim 13, wherein the plurality of slots are evenly spaced across a portion of the top surface.

15. The attachable magnification device of claim 11, wherein the attachable magnification device extends about one-third of the length of the file folder.

16. The attachable magnification device of claim 11, wherein the magnifying surface comprises at least one of glass, polyethylene, polypropylene, polycarbonate, polymethyl methacrylate or blends thereof.

17. An organizational apparatus comprising:
a base portion;
a substantially transparent or translucent magnifying surface;
at least one of a hinge, a pin, a pivot joint, a clip, a spring-loaded lock, or a tab-like projection, for removably attaching the attachable magnification device to at least one of a file folder, a hanging folder, a book, a magazine, a newspaper, a binder, or a report; and
a label holding portion defined between the base portion and the magnifying surface, having a label substantially disposed therein.

18. The organizational apparatus of claim 17, wherein the magnifying surface comprises at least one of glass, polyethylene, polypropylene, polycarbonate, polymethyl methacrylate or blends thereof.

19. The organizational apparatus of claim 17, wherein the magnifying surface comprises a colorant.

20. The organizational apparatus of claim 17, wherein at least a magnifying surface is semi-circular or semi-ovoid.
